(19) United States
(12) Patent Application Publication
(10) Pub. No.: US 2019/0265385 A1
(43) Pub. Date: Aug. 29, 2019

(54) PHOTOELECTRIC SENSOR

(71) Applicant: Omron Corporation, Kyoto (JP)

(72) Inventors: Hiroyuki Miyamoto, Kyoto (JP); Jun Nakajima, Kyoto (JP)

(73) Assignee: Omron Corporation, Kyoto (JP)

(21) Appl. No.: 16/359,206

(22) Filed: Mar. 20, 2019

Related U.S. Application Data
(63) Continuation of application No. PCT/JP2017/041693, filed on Nov. 20, 2017.

(30) Foreign Application Priority Data
Mar. 1, 2017 (JP) 2017-038411

(51) Int. Cl. G01V 8/14

(52) U.S. Cl. CPC G01V 8/14

(57) ABSTRACT

A photoelectric sensor includes: a light emitter; a reflector configured to reflect light emitted from the light emitter on a reflection surface; and a light receiver configured to receive the light reflected by the reflector. A detection object that has a sheet shape or flat plate shape and is located between the light emitter and the light receiver and the reflector is detected based on an amount of light received by the light receiver. The reflection surface is inclined with respect to a surface of the detection object on which the light reflected by the reflection surface is incident. The reflector reflects light such that the light is obliquely incident on the surface of the detection object at an incident angle of greater than or equal to 60°.

### TECHNICAL FIELD

The present invention relates to a photoelectric sensor, for example, a photoelectric sensor that detects a detection object.

### BACKGROUND

Conventionally, a photoelectric sensor is used to detect a thin sheet-shaped or flat plate-shaped detection object (such as a banknote and wrapping paper) conveyed by a belt conveyor in a manufacturing line of a factory.

FIG. 6 is a schematic diagram illustrating an example of a configuration of a conventional photoelectric sensor 900. As illustrated in FIG. 6, the photoelectric sensor 900 includes a light emitting unit 910 and a light receiving unit 920. A detection object A is conveyed in a direction perpendicular to a paper surface, and passes between the light emitting unit 910 and the light receiving unit 920. The light emitting unit 910 emits light toward the light receiving unit 920. When the detection object A passes between the light emitting unit 910 and the light receiving unit 920, a part of the light emitted from the light emitting unit 910 is reflected by the detection object A. For this reason, in the case that the detection object A exists, an amount of light received by the light receiving unit 920 decreases as compared with the case that the detection object A does not exist between the light emitting unit 910 and the light receiving unit 920. Thus, the photoelectric sensor 900 can detect the detection object A based on the amount of light received by the light receiving unit 920.

Patent Document 1 discloses a regressive reflection type photoelectric sensor further including a mirror in addition to the light emitting unit and the light receiving unit. In the regressive reflection type photoelectric sensor, the light emitted from the light emitting unit is reflected by the mirror, and the light reflected by the mirror is received by the light receiving unit. In this configuration, the detection object is conveyed between the light emitting unit and light receiving unit and the mirror.

### PRIOR ART DOCUMENTS

### Patent Documents

Patent Document 1: Japanese Unexamined Patent Publication No. 10-111365

Patent Document 2: Japanese Unexamined Patent Publication No. 2008-112629

### SUMMARY

In recent years, transparent banknotes have been increased worldwide. The photoelectric sensor 900 in FIG. 6 and the regressive reflection type photoelectric sensor of Patent Document 1 hardly detect a transparent detection object. In the photoelectric sensor described in Patent Document 2, a non-polarized component of light reflected on a surface of the detection object is cut by a polarizing filter. The light receiving unit receives only a polarized component transmitted through the polarizing filter. For this reason, an amount of light received in the case that the detection object exists is smaller than the amount of light received in the case that the detection object does not exist. However, the photoelectric sensor described in Patent Document 2 includes expensive optical components such as the polarizing filter and a polarizing plate, which increases cost. Additionally, in the case that the detection object does not non-polarize the polarized light so much, the photoelectric sensor of Patent Document 2 hardly detects the detection object.

The present invention provides a photoelectric sensor capable of detecting a transparent detection object with a simple configuration.

According to one aspect of the present invention, a photoelectric sensor includes: a light emitting unit; a reflector configured to reflect light emitted from the light emitting unit on a reflection surface; and a light receiving unit configured to receive the light reflected by the reflector, in which a detection object that has a sheet shape or flat plate shape and is located between the light emitting unit and light receiving unit and the reflector is detected based on an amount of light received by the light receiving unit, and the reflection surface is inclined with respect to a surface of the detection object on which the light reflected by the reflection surface is incident.

In one aspect of the present invention, the transparent detection object can be detected with a simple configuration.

### BRIEF DESCRIPTION OF THE DRAWINGS

FIG. 1 is a schematic diagram illustrating arrangement of a main part configuration included in a photoelectric sensor according to one or more embodiments.

FIG. 2 is a view illustrating a partial configuration of an inspection device including the photoelectric sensor according to one or more embodiments.

FIG. 3 is a view illustrating a path of light emitted from a light emitting unit included in the photoelectric sensor according to one or more embodiments.

FIG. 4 is a graph illustrating a relationship between an incident angle of light on a detection object and a light transmittance according to one or more embodiments.

FIG. 5 is a schematic diagram illustrating a configuration of a reflection type photoelectric sensor according to one or more embodiments.

FIG. 6 is a schematic diagram illustrating an example of a configuration of a conventional photoelectric sensor.

### DETAILED DESCRIPTION

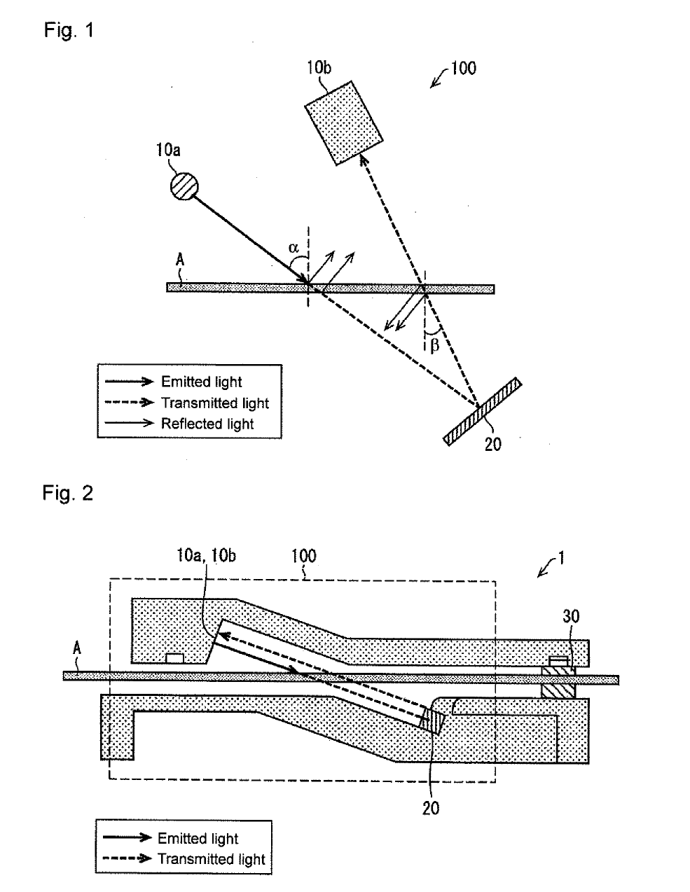

Hereinafter, embodiments of the present invention will be described in detail with reference to FIGS. 1 to 4.

(Configuration of Inspection Device 1)

FIG. 2 is a diagram illustrating a partial configuration of an inspection device 1 according to one or more embodiments. As illustrated in FIG. 2, the inspection device 1 includes a light emitting unit (light emitter) 10a, a light receiving unit (light receiver) 10b, a reflector 20, and a conveyance device 30. The light emitting unit 10a, the light receiving unit 10b, and the reflector 20 are included in a photoelectric sensor 100 (to be described later).

The light emitting unit 10a emits light toward the reflector 20. For example, the light emitting unit 10a includes a light emitting element such as a light emitting diode (LED) and a laser diode (LD). For example, the light receiving unit 10b includes a photodiode or a phototransistor. The light receiving unit 10b receives the light reflected by the reflector 20, and performs photoelectric conversion on the received light. The light receiving unit 10b transmits current generated by the photoelectric conversion to the photoelectric sensor 100 or a controller (not illustrated) of the inspection device 1. The reflector 20 reflects the light received from the light emitting unit 10a toward the light receiving unit 10b. For example, the reflector 20 includes a mirror including a mirror surface (reflection surface).

The conveyance device 30 conveys a detection object A in a left or right direction of FIG. 2 between the light emitting unit 10a and light receiving unit 10b and the reflector 20. For example, the conveyance device 30 is constructed with rollers between which both surfaces of the detection object A are sandwiched and a motor that drives the rollers.

In FIG. 2, the detection object A has a sheet shape. However, the detection object A may have one surface facing the reflector 20 and a surface on an opposite side facing the light emitting unit 10a and the light receiving unit 10b. For example, the detection object A may have a flat plate shape. For example, the detection object A is a banknote or wrapping paper. A part or the whole of the detection object A may be made of a transparent material (for example, a polymer resin).

The photoelectric sensor 100 or the inspection device 1 calculates the amount of transmitted light based on a voltage value or a current value obtained by performing the photoelectric conversion on the light received by the light receiving unit 10b. Then, the photoelectric sensor 100 or the inspection device 1 determines the existence of the detection object A based on the calculated amount of the transmitted light. For example, the photoelectric sensor 100 or the inspection device 1 determines that the detection object A does not exist when the amount of the transmitted light exceeds a threshold. On the other hand, the photoelectric sensor 100 or the inspection device 1 determines that the detection object A exists when the amount of the transmitted light is less than or equal to the threshold.

(Configuration of Photoelectric Sensor 100)

FIG. 1 illustrates arrangement of the main part configuration included in the photoelectric sensor 100. As illustrated in FIG. 1, in the photoelectric sensor 100, the light emitting unit 10a and the light receiving unit 10b are located on the same side with respect to the detection object A conveyed by the conveyance device 30 of the inspection device 1, and the reflector 20 is located on the side opposite to the light emitting unit 10a and the light receiving unit 10b with respect to the detection object A. In other words, the detection object A faces the reflector 20 on one of surfaces of the detection object A, and faces the light emitting unit 10a and the light receiving unit 10b on the surface on the opposite side.

As illustrated in FIG. 1, the light (emitted light) emitted from the light emitting unit 10a of the photoelectric sensor 100 is incident on the detection object A at an incident angle α. The incident angle α may be any angle that is greater than or equal to 0° and is less than 90°. When the emitted light is incident on the detection object A at the incident angle α, part of the emitted light is scattered at an interface between air (outside) and the detection object A. In the case that the detection object A is non-transparent, the light attenuates while transmitted through the detection object A. When the light is emitted from the detection object A, part of the light is scattered at the interface between the air and the detection object A. The light transmitted through the detection object A is reflected by the reflector 20, and is incident on the detection object A at an incident angle β again. The incident angle β may be any angle that is greater than 0° and is less than 90°. Part of the light incident on the detection object A at the incident angle 13 is scattered. In the case that the detection object A is non-transparent, the light attenuates while transmitted through the detection object A. When the light is emitted from the detection object A, part of the light is scattered again at the interface between the air and the detection object A. Although not illustrated, the light is multiple-reflected in the detection object A. The light (transmitted light) transmitted through the detection object A is received by the light receiving unit 10b.

In FIG. 1, instead of the light emitting unit 10a, an emitting port of an optical fiber guiding the light emitted from the light emitting unit 10a may be disposed at a position where the light emitting unit 10a is located. Instead of the light receiving unit 10b, a light receiving port of the optical fiber guiding the light to the light receiving unit 10b may be disposed at a position where the light receiving unit 10b is located. With this configuration, a degree of arrangement freedom of the light emitting unit 10a and the light receiving unit 10b is improved in the inspection device 1 (see FIG. 2).

In the conventional photoelectric sensor, the reflection surface of the reflector is parallel to the surface of the detection object. For this reason, for example, in the case that the detection object is close to the reflection surface, the direction in which the light reflected by the surface of the detection object is directed is substantially the same as the direction in which the light reflected by the reflection surface is directed. In such a case, part of the light reflected on the surface of the detection object is incident on the light receiving unit. As a result, the change of the amount of light received by the light receiving unit is decreased between the case that the detection object exists and the case that the detection object does not exist to hardly detect the detection object.

On the other hand, as can be seen from FIG. 1, in the photoelectric sensor 100 according to one or more embodiments, the surface of the detection object A and the reflection surface of the reflector 20 are directed in directions different from each other. Thus, the light reflected by the reflector 20 is incident on the light receiving unit 10b, but the light reflected on the surface of the detection object A is not incident on the light receiving unit 10b. Thus, the light reflected on the surface of the detection object A has a little influence on the change of the amount of light received by the light receiving unit 10b.

(Relationship between Incident Angle α and Transmittance t)

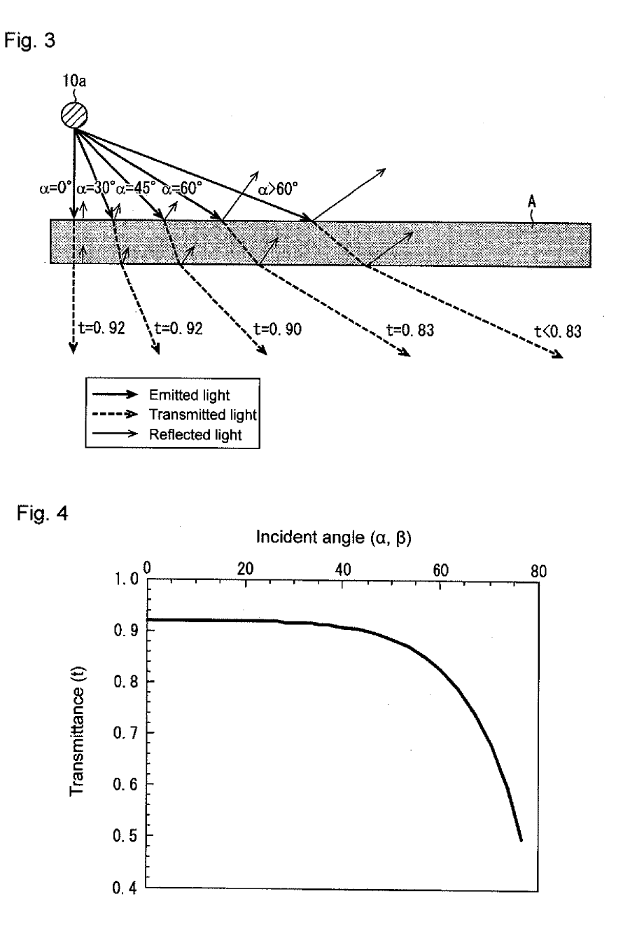

FIG. 3 is a view illustrating the relationship between the incident angle α when the light emitted from the light emitting unit 10a is incident on the detection object A and a transmittance t of the light transmitted through the detection object A. The transmittance t is a ratio of the amount of light transmitted through the detection object A to the amount of light incident on the detection object A. In FIG. 3, specifically the detection object A is a transparent polymer resin sheet having a refractive index of 1.5. The surrounding of the detection object A is air. As illustrated in FIG. 3, generally the transmittance t of the light varies depending on the incident angle α. For example, in the case that the incident angle α is 0°, the transmittance t is about 0.92. On the other hand, in the case that the incident angle α is 60°, the transmittance t is about 0.83. Although not illustrated, the same holds true for the relationship between the incident angle β of the light reflected by the reflector 20 and the transmittance t of the light transmitted through the detection object A.

FIG. 4 is a graph illustrating the relationship between the incident angles α, β of the light and the transmittance t of the light. As illustrated in FIG. 4, generally the transmittance t decreases with increasing incident angles α, β. The reason why the transmittance t of the light varies according to the incident angles α, β is that a ratio of the light Fresnel-reflected at the interface between the air and the detection object A increases with increasing incident angles α, β. Because an optical distance of the light transmitted through the detection object A becomes longer with increasing incident angles α, β, the light attenuates in the detection object A in the case that the detection object A is not completely transparent, and this is also the reason why the transmittance t is decreased.

In one or more embodiments, the light emitted from the light emitting unit 10a is incident obliquely to the surface of the detection object A (that is, at an incident angle α that is greater than 0° and is less than 90°. The light reflected by the reflector 20 is incident obliquely to the surface of the detection object A (that is, at an incident angle β that is greater than 0° and is less than 90°. For this reason, the Fresnel reflectance increases (see FIG. 3) as compared with the configuration in which the light is incident on the surface of the detection object A in the vertical direction. As a result, the amount of light received by the light receiving unit 10b decreases. Because the optical distance transmitted through the detection object is long, particularly in the case that the detection object A is non-transparent, the light attenuates in the detection object A, whereby the transmittance t further decreases. This also decreases the amount of light received by the light receiving unit 10b.

As can be seen from FIG. 4, in the case that the incident angles α, β are greater than or equal to about 60°, the transmittance t decreases rapidly with increasing incident angles α, β. Because the amount of light received by the light receiving unit 10b of the photoelectric sensor 100 decreases with decreasing transmittance t, the existence of the detection object A can be more correctly determined based on the change of the amount of received light. Thus, desirably the incident angles α, β are greater than or equal to 60°.

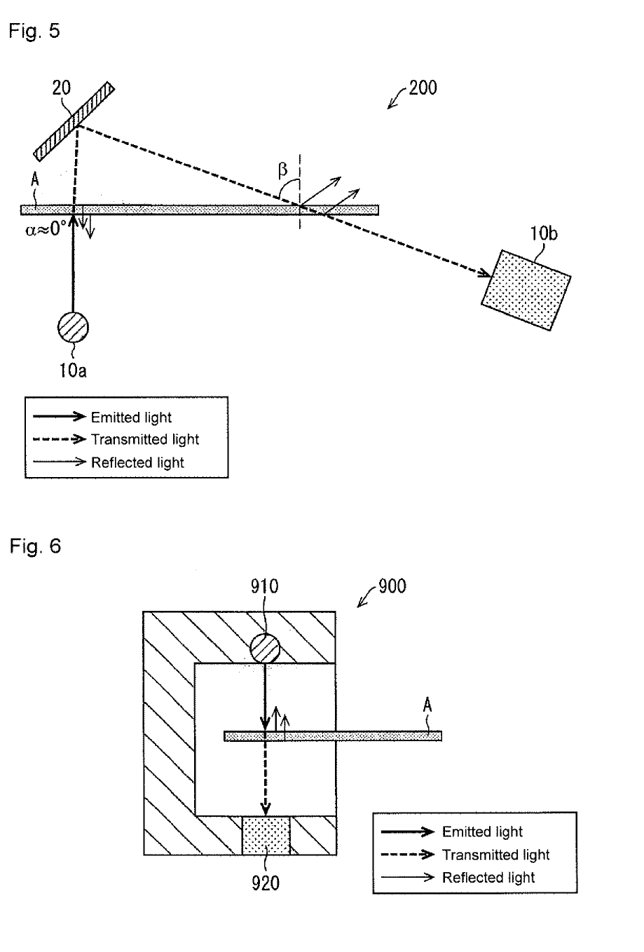

One or more embodiments of the present invention will be described below with reference to FIG. 5. For convenience, a member having the same functions as the member described in the embodiments above is denoted by the same reference numerals, and the description will be omitted.

(Configuration of Photoelectric Sensor 200)

FIG. 5 is a schematic diagram illustrating a configuration of a photoelectric sensor 200 according one or more embodiments. As illustrated in FIG. 5, even in the photoelectric sensor 200 according to one or more embodiments, similarly to the photoelectric sensor 100 of the embodiments described above, a light emitting unit 10a and a light receiving unit 10b are located on the same side with respect to the detection object A, and a reflector 20 is located on the side opposite to the light emitting unit 10a and the light receiving unit 10b with respect to the detection object A.

In one or more embodiments, the incident angle α is about 0° when the light emitted from the light emitting unit 10a is incident on the detection object A. That is, the light emitted from the light emitting unit 10a is substantially perpendicularly incident on the surface of the detection object A. On the other hand, similarly to the embodiments described above, the incident angle β is greater than 0°, preferably greater than or equal to about 60° when the light reflected by the reflector 20 is incident on the detection object A. That is, in one or more embodiments, an optical axis of the light emitting unit 10a and an optical axis of the light receiving unit 10b intersect each other at an angle that is greater than 0°, preferably greater than or equal to about 60°.

In FIG. 5, the positions of the light emitting unit 10a and the light receiving unit 10b may be exchanged. In this configuration, the light emitted from the light emitting unit 10a is incident on the surface of the detection object A at an incident angle α that is greater than 0°, preferably greater than or equal to about 60°. The light reflected by the reflector 20 is substantially perpendicularly incident on the surface of the detection object A. That is, the incident angle β is about 0°.

In one or more embodiments, the distance between the light emitting unit 10a and the reflector 20 is shorter than that of the configuration of the embodiments described above. Consequently, the inspection device 1 (see FIG. 2) can be made more compact. In one or more embodiments, the position at which the light receiving unit 10b receives the transmitted light can easily be changed by changing the direction in which the reflector 20 reflects the light. For example, in the case that the detection object A is a blank sheet, because the amount of light that is reflected by the detection object A and is incident on the light receiving unit 10b becomes larger than the amount of light that is reflected by the reflector 20 and is incident on the light receiving unit 10b when the light emitting unit 10a and the light receiving unit 10b are excessively close to each other, there is a possibility that the object cannot be detected. In such a case, the light emitting unit 10a is moved away from the light receiving unit 10b by adjusting the direction in which the reflector 20 reflects the light, so that the light reflected by the detection object A is not incident on the light receiving unit 10b.

(Summary)

As described above, according to a first aspect of the present invention, a photoelectric sensor includes: a light emitting unit; a reflector configured to reflect light emitted from the light emitting unit on a reflection surface; and a light receiving unit configured to receive the light reflected by the reflector, in which a detection object that has a sheet shape or flat plate shape and is located between the light emitting unit and light receiving unit and the reflector is detected based on an amount of light received by the light receiving unit, and the reflection surface is inclined with respect to a surface of the detection object on which the light reflected by the reflection surface is incident.

With the above configuration, at least one of the light emitted from the light emitting unit toward the reflector and the light reflected by the reflector is obliquely incident on the surface of the detection object. For this reason, part of the light is reflected at the interface between an external world and the detection object. Generally the case that the light is obliquely incident on the surface of the detection object is higher than the case that the light is perpendicularly incident on the surface of the detection object in the reflectance at the interface (Fresnel reflection). For this reason, in the case that the detection object exists, the amount of light received by the light receiving unit is largely decreased by the amount of reflected light. Thus, even if the detection object is transparent, the detection object can be detected based on the amount of light received by the light receiving unit.

In the conventional configuration, because the reflection surface of the reflector is parallel to the surface of the detection object, sometimes part of the light reflected by the surface of the detection object is incident on the light receiving unit. For example, in the case that the detection object is close to the reflection surface, the direction in which the light reflected by the surface of the detection object is directed is substantially the same as the direction in which the light reflected by the reflection surface is directed. In such a case, part of the light reflected on the surface of the detection object is incident on the light receiving unit. As a result, the change of the amount of light received by the light receiving unit is decreased between the case that the detection object exists and the case that the detection object does not exist to hardly detect the detection object. On the other hand, with the above configuration, because the reflection surface of the reflector is inclined with respect to the surface of the detection object, the direction in which the light reflected by the surface of the detection object is directed is different from the direction in which the light reflected by the reflection surface is directed, namely, the direction of the light receiving unit. Thus, the light reflected on the surface of the detection object is not incident on the light receiving unit.

According to a second aspect of the present invention, in the photoelectric sensor, the reflector may reflect light such that the light is obliquely incident on the surface of the detection object at an incident angle of greater than or equal to 60°.

The inventors have investigated the relationship between the incident angle of the light and the transmittance with respect to the transparent detection object. In the case that the incident angle of the light is greater than or equal to 60°, the amount of light reflected on the surface of the detection object becomes extremely large as compared with the case that the incident angle of the light is less than 60°. As a result, the inventors have conceived to utilize the fact that the transmittance drops largely. With the above configuration, because the light reflected by the reflector is obliquely incident on the surface of the detection object at the incident angle of greater than or equal to 60°, the amount of light received by the light receiving unit is greatly decreased. Thus, even if the detection object is transparent, the detection object can correctly be detected.

According to a third aspect of the present invention, in the photoelectric sensor, the light emitting unit may emit light such that the light is obliquely incident on a surface on a side opposite to the detection object.

With the above configuration, because the light emitted from the light emitting unit is obliquely incident on the surface on the side opposite to the detection object, part of the light is reflected at the interface between the external world and the detection object (Fresnel reflection). For this reason, the amount of light received by the light receiving unit in the case that the detection object exists is smaller than the amount of light received by the light receiving unit in the case that the detection object does not exist. Thus, the detection object can be detected based on the change of the amount of light received by the light receiving unit.

According to a fourth aspect of the present invention, in the photoelectric sensor, the light emitting unit may emit light such that the light is obliquely incident on the surface on a side opposite to the detection object at an incident angle of greater than or equal to 60°.

As described above, in the case that the incident angle of the light is greater than or equal to 60°, the transmittance decreases largely as compared with the case that the incident angle of the light is less than 60°. With the above configuration, because the light emitted from the light emitting unit is obliquely incident on the surface on the side opposite to the detection object at the incident angle of greater than or equal to 60°, the transmittance decreases largely, and resultantly the amount of light received by the light receiving unit decreases largely. Thus, even if the detection object is transparent, the detection object can correctly be detected.

The present invention is not limited to the above embodiments, various changes can be made without departing from the scope of the claims, and an embodiment acquired by a combination of technical means disclosed in different embodiments is also included in the technical scope of the present invention.

### DESCRIPTION OF SYMBOLS

100, 200 photoelectric sensor

10a light emitting unit

10b light receiving unit

20 reflector

A detection object

1. A photoelectric sensor comprising:
a light emitter;
a reflector that reflects light emitted from the light emitter on a reflection surface; and
a light receiver that receives the light reflected by the reflector,
wherein a detection object that has a sheet shape or flat plate shape and is located between the light emitter and the light receiver and the reflector is detected based on an amount of light received by the light receiver, and
the reflection surface is inclined with respect to a surface of the detection object on which the light reflected by the reflection surface is incident, and
the reflector reflects light such that the light is obliquely incident on the surface of the detection object at an incident angle of greater than or equal to 60°.

2. The photoelectric sensor according to claim 1, wherein the light emitter emits light such that the light is obliquely incident on a surface on a side opposite to the detection object.

3. The photoelectric sensor according to claim 2, wherein the light emitter emits light such that the light is obliquely incident on the surface on the side opposite to the detection object at the incident angle of greater than or equal to 60°.

4. A photoelectric sensor comprising:
a light emitter;
a reflector that reflects light emitted from the light emitter on a reflection surface; and
a light receiver that receives the light reflected by the reflector,
wherein a detection object that has a sheet shape or flat plate shape and is located between the light emitter and the light receiver and the reflector is detected based on an amount of light received by the light receiver, and
the light emitter emits light such that the light is obliquely inclined on a surface on a side opposite to the detection object at an incident angle of greater than or equal to 60°.
